(19) United States
(12) Patent Application Publication
(10) Pub. No.: US 2014/0040236 A1
(43) Pub. Date: Feb. 6, 2014

(54) VISUALIZATION OF TOP LOCAL GEOGRAPHICAL ENTITIES THROUGH WEB SEARCH DATA

(71) Applicants: Deepak Vijaywargi, Bellevue, WA (US); Frédéric Dubut, Seattle, WA (US)

(72) Inventors: Deepak Vijaywargi, Bellevue, WA (US); Frédéric Dubut, Seattle, WA (US)

(73) Assignee: Microsoft Corporation, Redmond, WA (US)

(21) Appl. No.: 13/562,334

(22) Filed: Jul. 31, 2012

(51) Int. Cl. G06F 17/30

(52) U.S. Cl. 707/722; 707/E17.014

(57) ABSTRACT

Architecture that automatically employs web search user query data to identify the places (e.g., locations, businesses) to which people are likely traveling, and then produces a heatmap visualization of the most popular places in the local area on a local map in a mapping application, which is then viewable in the vertical listing of the search results. This data can be utilized to rank local businesses in terms of popularity by knowing how many people are actually visiting the business as a function of date (and perhaps time). The web search data, which is used to understand the popular locations of a geographical area, includes signals such as searching for directions in the map application, and analyzing directions-related terms such as “From” and “To” in the search results. Another signal can be a location or business search which triggers an appropriate instant answer.

### BACKGROUND

Search engines do not provide a good way of showing the most happening events in a given city and time, usually displaying a static list of top attractions. Often this is not useful in that knowledge about what to do on a particular day in a year is more interesting. For example, where to watch fireworks on a national holiday or what area is the most crowded and can be avoided if driving by car, are more useful pieces of information.

Existing solutions include check-in software at a business that notifies a service the user is currently at the business. However, this commonly used approach negatively impacts the user experience, since it requires manual human intervention.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture automatically employs web search user query data to identify geographical entities of interest and where people are likely to travel. A graphical visualization of the top entities (e.g., activities, locations, businesses, etc.) is presented on a local map as part of search results of the search engine results page (SERP), and in a mapping application, if the user chooses a more detailed view. This data can be utilized to rank local entities such as businesses, for example, in terms of popularity by computing how many people are actually visiting the business as a function of time (and perhaps, date).

The web search data, which is used to understand the popular entities of a geographical area, includes signals such as searching for directions via a search engine, using the map application, and analyzing the vertical results listing (of the SERP) where result metadata includes “From” and “To” address terminology, for example. Another signal can be an entity such as a location or business search in the web vertical section, which triggers an appropriate instant answer.

More generally, any search that can be geocoded (into geographical coordinates) can be processed and analyzed. Processing this geocoded data as function of time and a geographical area (e.g., metropolitan area) provides an indication of entities (e.g., events) that are occurring, where the entities are occurring and the time of the entity occurrence. Using the web search data of the users actually looking to travel to the geographic entities, the entities can be ranked.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an exemplary search results page showing a vertical listing of results of popular geographic locations derived from web search data.

FIG. 3 illustrates a search engine results page with a vertical listing of results.

FIG. 4 illustrates an exemplary heatmap displayed in a map user interface.

FIG. 5 illustrates a method in accordance with the disclosed architecture.

FIG. 6 illustrates an alternative method in accordance with the disclosed architecture.

FIG. 7 illustrates a block diagram of a computing system that executes the visualization of the top local geographical entities derived from web search data in accordance with the disclosed architecture.

### DETAILED DESCRIPTION

The disclosed architecture automatically employs web search user query data to identify the geographic entities (e.g., locations, events, activities, businesses, etc.) to which people are likely traveling, and then produces a graphical visualization (e.g., a heatmap) of the most popular places in the local area on a local map (e.g., in a mapping application). As a heatmap, data is graphically represented as colors, where the different data values are represented as correspondingly lighter or darker shades of the colors, such as a gradient. For example, larger data values can be represented as darker colors on a map, while smaller data values can be represented as lighter colors. The local map can then be viewed generally in the vertical listing of the search results and in more detail in a map application. This data can be utilized to rank local businesses in terms of popularity by knowing how many people are actually visiting the business as a function of date (and perhaps time). The web search data, which is used to understand the popular entities of a geographical area, includes signals such as searching for directions via a search engine, via the map application, and analyzing directions-related terms such as “From” and “To” in the search results, for example. Another signal can be a location or business search in a search engine which triggers an appropriate instant answer.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

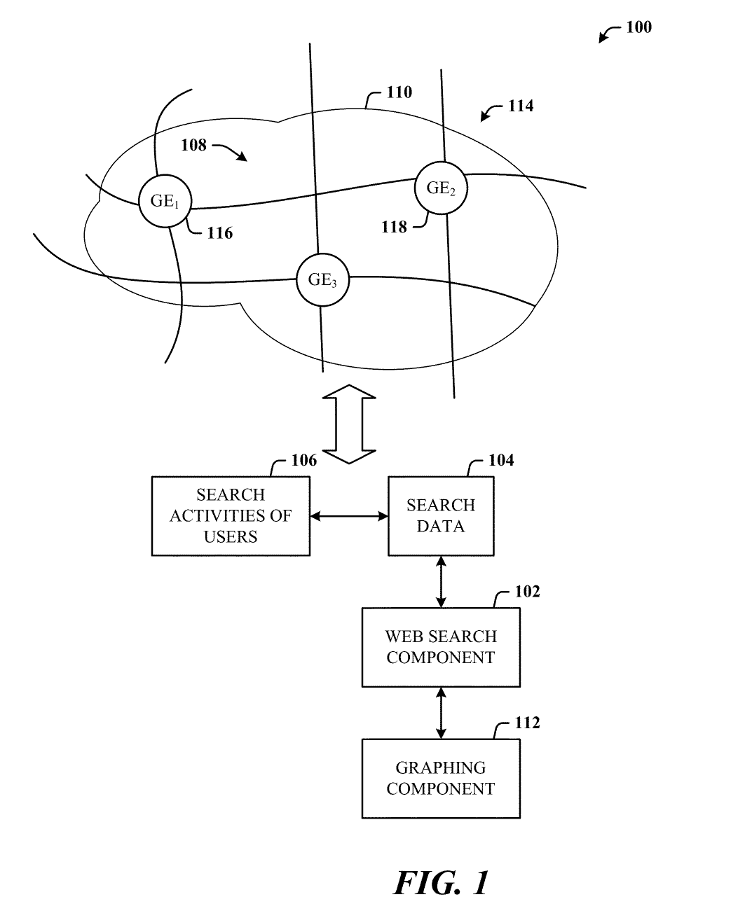

FIG. 1 illustrates a system 100 in accordance with the disclosed architecture. The system 100 can include a web search component 102 that analyzes search data 104 derived from search activities 106 of users to determine popularity of geographic entities (denoted GE₁, GE₂, and GE₃) 108 in a geographic area 110. A graphing component 112 applies graphical emphasis (e.g., coloration, color gradients, geometric graphics, annotations such as tags, etc.) to the identified popular geographic entities 108 on a map 114 of the geographic area 110.

The graphical emphasis is applied proportional to the popularity of the geographic entities 108 (which can be general locations such as parks, more specific entities such as businesses, events (e.g., concerts) associated with a location, activities, etc.) as derived from the search activities 106. In other words, the more popular the geographic entity, the greater the graphical emphasis, and the lesser the popularity, the lesser the graphical emphasis. Thus, it is readily visible to the user that one geographic entity, a first geographic entity 116, has greater popularity than a second geographic entity 118, based on search data analysis that indicates more people intend to visit the first geographic entity 116.

The search data 104 can include search activities for directions in at least one of a map application or a web search engine. The search data 104 can include search activities for a geographical entity, which is a location, in at least one of a map application or a web search engine. The search data 104 can include search activities for a geographical entity, which is a business, in at least one of a map application or a web search engine. The search data 104 can be processed as a function of time and geographical area 110 to determine time associated with the geographical entity and location of the geographical entity. The search data 104 of multiple users is processed to rank local entities based in part on users searching to travel to the entity.

The search data 104 of multiple users can be aggregated over a geographical area 110 and stored based on date and time. The search data 104 of multiple users is analyzed to identify the entities and associated geographical coordinates (e.g., latitude and longitude). The graphing component 112 creates the map 114 that includes the geographical coordinates of the entities 108, and the graphical emphasis for a top number of popular entities is represented as a heatmap overlaid on the map 114.

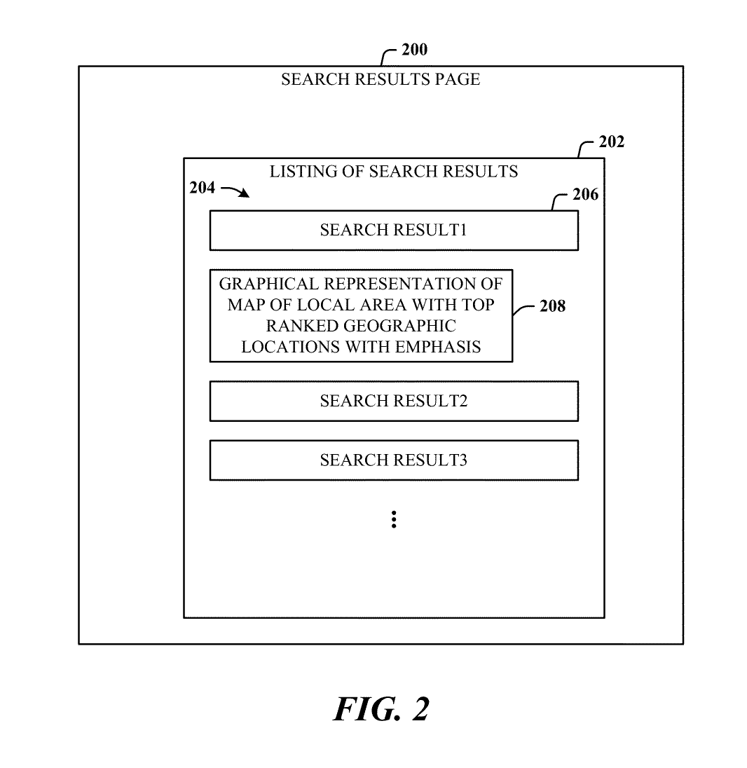

FIG. 2 illustrates an exemplary search results page 200 showing a vertical listing 202 of results 204 of popular geographic locations derived from web search data. The listing 202 includes a first search result 206, which includes a descriptive title as an active hyperlink to more detailed information, and a graphical representation 208 under the result 206 of a map of the local area with top ranked popular locations denoted with varying degrees of graphical emphasis to visually differentiate ranking of the locations, businesses, or activities. Thus, the SERP presents the popular locations, businesses, and/or activities in a city based on the web search data of many users at a given time and data.

The web search data can include “signals” or trigger information (e.g., search terms) that indicate the data can be considered for analysis to understand the popular locations. The signals include, but are not limited to, driving directions search queries from mobile devices (e.g., cell phones) and/or computers in a mapping application where a user enters “from” and “to” addresses, and a location, activity, or business search in the search user interface of a search engine, which triggers an appropriate instant answer.

More generally, any search that can be geocoded can be analyzed for popularity processing. Moreover, this data can be processed as function of time and a metropolitan area, for example, which can present a clear visualization of what is happening, where and when. More generally, any search query that can be geocoded (associated with unique latitude and longitude coordinates) can be used.

The web search data can be aggregated over all users in a given geographical (e.g., metropolitan) region. Obtaining this data as a function of time returns a list of all activities, locations, and/or businesses for consideration. These activities, locations, and/or businesses (=addresses) are converted to unique latitude and longitude coordinates. An area of interest is defined by using a fixed radius that circumscribes a given latitude and longitude. Data smoothing can be applied to remove noise, for example, to obtain a set of top places to which people may be traveling. This data of top places, activities, etc., can then be displayed (e.g., as a heatmap) in combination with or on top of a vertical listing of mapping results.

Data ranking provides some indication as to the number of users who are actually looking to travel to the geocoded entity (e.g., activity, location, business, etc.).

This data can be stored and then analyzed for historically for trends. Thus, future search data that aligns in some statistical way with the historical data can indicate the likelihood that a previously-selected entity is again a top popular selection. In other words, the entity exhibits a consistency as to a popular place, activity, location, or business.

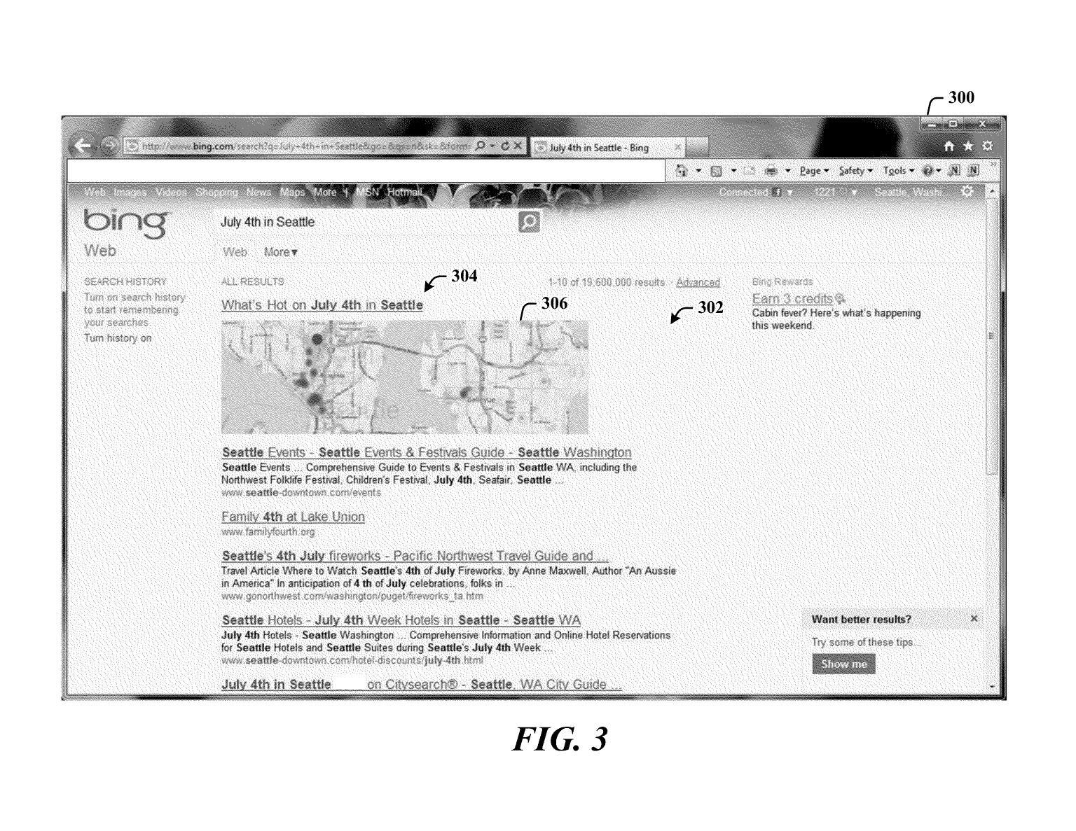

FIG. 3 illustrates a search engine results page 300 with a vertical listing of results 302. A first result 304 is titled “What's Hot on July 4^{th} in Seattle” and further includes an automatically generated local map 306 of entities (activities, locations, businesses) that are currently determined to be the most popular entities, as derived from web search data of many users entered at the date and time. It is to be understood that since the web search data is derived from many users, a shift in user interest, as determined from the user queries, can then result in a change in the popular spots as indicated on the local map. Such a shift in interests can occur in realtime, since the number of users searching can be very large from search to search. In this example, the graphical emphasis of the top ranked entities is presented as a heatmap for viewing by users conducting similar searches.

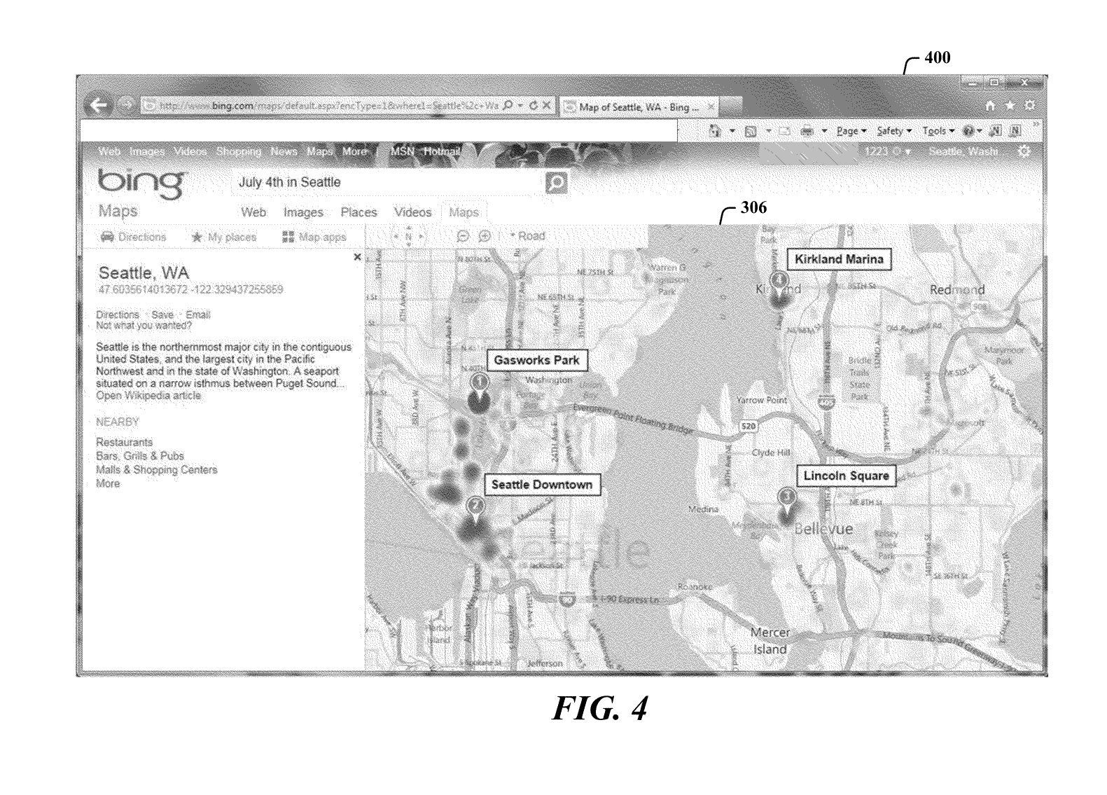

FIG. 4 illustrates an exemplary heatmap displayed in a map user interface 400. When the user selects (clicks on) the local map 306 of FIG. 3 (or the result 304), a map application presents the heatmap of the top ranked hot-spots currently being searched by users. In this example, the top spots are annotated with tags 1, 2, 3, and 4 to indicate the ranking of the top selected spots for presentation, as presented in FIG. 3, but due to the smaller view, are not presented. As shown, the popularity (or top ranked) graphics are laid on top of the local map.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

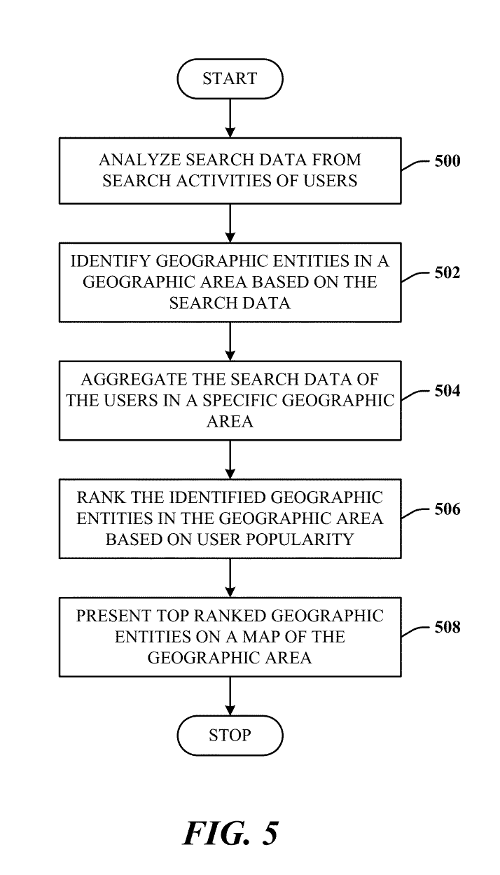

FIG. 5 illustrates a method in accordance with the disclosed architecture. At 500, search data (e.g., web search) from search activities of users is analyzed. At 502, geographic entities in a geographic area are identified based on the search data. At 504, the search data of the users in a specific geographic area is aggregated. At 506, the identified geographic entities in the geographic area are ranked based on user popularity. At 508, top ranked geographic entities are presented on a map of the geographic area.

The method can further comprise acts of presenting the top ranked geographic entities as a heatmap of the geographic area, presenting the heatmap in the results listing of a search engine results page, and processing the search data as a function of time and date. The method can further comprise acts of obtaining the web search data from address queries in a map application, processing only web search data that is geocoded, and identifying users interested in given geographic entities based on the aggregation of the search data.

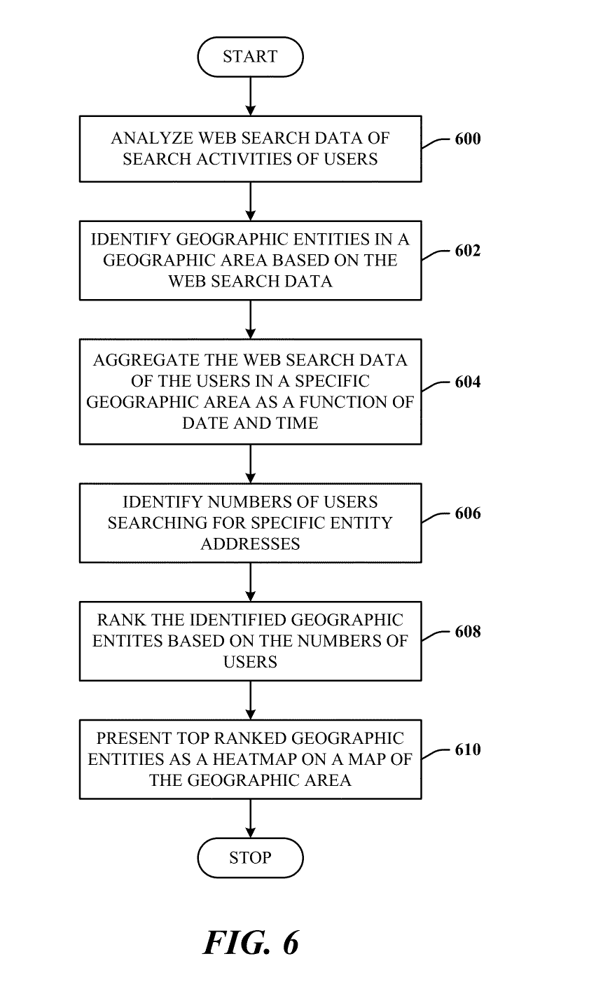

FIG. 6 illustrates an alternative method in accordance with the disclosed architecture. At 600, web search data of search activities of users is analyzed. At 602, geographic entities in a geographic area are identified based on the web search data. At 604, the web search data of the users in a specific geographical area is aggregated as a function of date and time. At 606, the numbers of users searching for specific entity addresses is identified. At 608, the identified geographic entities are ranked based on the numbers of users. At 610, the top ranked geographic entities are presented as a heatmap on a map of the geographic area.

The method can further comprise acts of ranking based on the number of users intending to travel to the geographic entity, analyzing the web search results for data that can be geocoded and identifying geographic entities in a geographic area based on the geocoded search data, and presenting the heatmap on a map of the geographic area in the listing of search results of a search engine results page.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

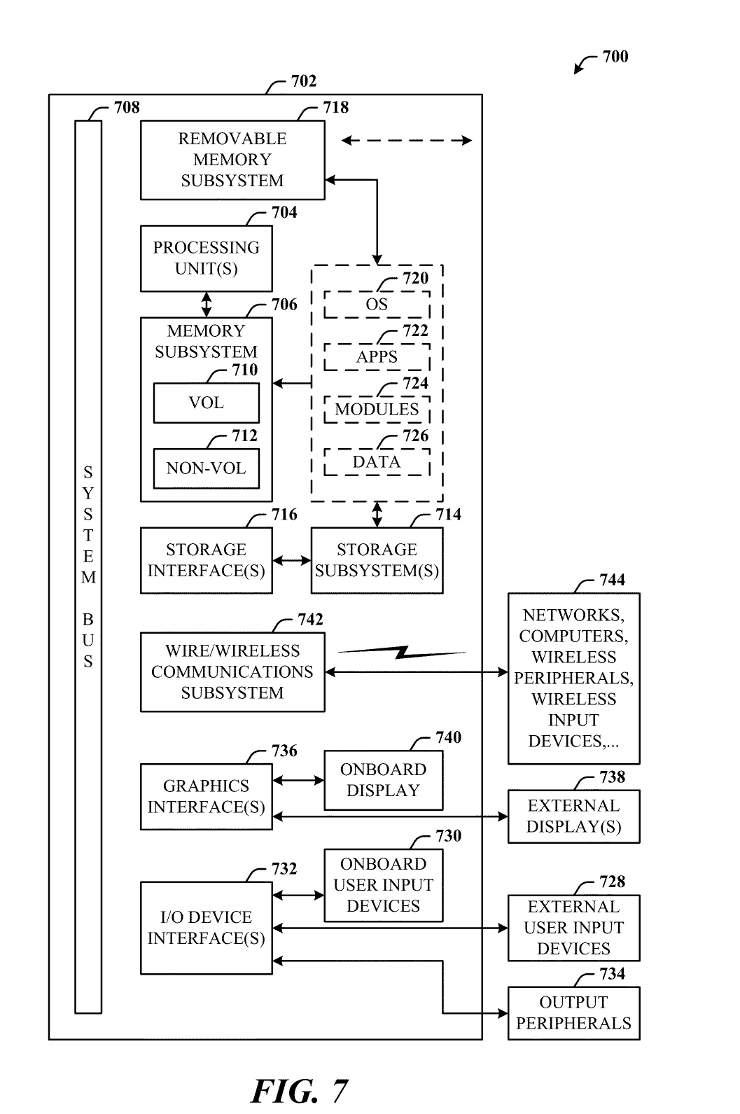

Referring now to FIG. 7, there is illustrated a block diagram of a computing system 700 that executes the visualization of the top local geographical entities derived from web search data in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. Moreover, mobile devices such as cell phones can utilize the disclosed architecture.

In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704, a computer-readable storage such as a system memory 706, and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 706 can include computer-readable storage (physical storage media) such as a volatile (VOL) memory 710 (e.g., random access memory (RAM)) and non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include entities and components of the system 100 of FIG. 1, entities and components of the results page 200 of FIG. 2, entities and components of the results page 300 of FIG. 3, entities and components of the interface 400 of FIG. 4, and the methods represented by the flowcharts of FIGS. 5 and 6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media which do not utilize propagated signals and that can be accessed by the computer 702 and includes volatile and non-volatile internal and/or external media that is removable or non-removable. For the computer 702, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 702, programs, and data using external user input devices 728 such as a keyboard and a mouse, as well as by voice commands facilitated by speech recognition. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example.

These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
a web search component that analyzes search data derived from search activities of users to determine popularity of geographic entities in a geographic area;
a graphing component that applies graphical emphasis to popular geographic entities on a map of the geographic area, the graphical emphasis applied using diff shades of colors based on respective popularities of the geographic entities as derived from the search activities; and
a microprocessor that executes computer-executable instructions in a memory.

2. The system of claim 1, wherein the search data includes search activities for directions in at least one of a map application or a web search engine.

3. The system of claim 1, wherein the search data includes search activities for a geographical entity, which is a location, in at least one of a map application or a web search engine.

4. The system of claim 1, wherein the search data includes search activities for a geographical entity, which is a business, in at least one of a map application or a web search engine.

5. The system of claim 1, wherein the search data is processed as a function of time and geographical area to determine time associated with the geographical entity and location of the geographical entity.

6. The system of claim 1, wherein the search data of multiple users is processed to rank local entities based in part on users searching to travel to the entity.

7. The system of claim 1, wherein the search data of multiple users is aggregated over a geographical area and stored based on date and time.

8. The system of claim 1, wherein the search data of multiple users is analyzed to identify the entities and associated geographical coordinates.

9. The system of claim 8, wherein the graphing component creates a map that includes the geographical coordinates of the entities, and the graphical emphasis for a top number of popular entities is represented as a heatmap overlaid on the map.

10. A method, comprising acts of:
analyzing search data from search activities of users;
identifying geographic entities in a geographic area based on the search data;
aggregating the search data of the users in a specific geographic area;
ranking the identified geographic entities in the geographic area based on user popularity;
presenting top ranked geographic entities as a heatmap on a map of the geographic area; and
utilizing a microprocessor that executes instructions stored in a memory.

11. (canceled)

12. The method of claim 10, further comprising presenting the heatmap in the results listing of a search engine results page.

13. The method of claim 10, further comprising processing the search data as a function of time and date.

14. The method of claim 10, further comprising obtaining the search data from address queries in a map application.

15. The method of claim 10, further comprising processing only the search data that is geocoded.

16. The method of claim 10, further comprising identifying users interested in given geographic entities based on the aggregation of the search data.

17. A method, comprising acts of:
analyzing web search data of search activities of users;
identifying geographic entities in a geographic area based on the web search data;
aggregating the web search data of the users in a specific geographic area as a function of date and time;
identifying numbers of users searching for specific entity addresses;
ranking the identified geographic entities based on the numbers of users;
presenting top ranked geographic entities as a heatmap on a map of the geographic area; and
utilizing a microprocessor that executes instructions stored in a memory.

18. The method of claim 17, further comprising ranking based on the number of users intending to travel to the geographic entity.

19. The method of claim 17, further comprising analyzing the web search results for data that can be geocoded and identifying geographic entities in a geographic area based on the geocoded search data.

20. The method of claim 17, further comprising presenting the heatmap on a map of the geographic area in the listing of search results of a search engine results page.

21. The system of claim 1, wherein the shade of a color is darker as the popularity of a geographic entity increases.
